(19) United States
(12) Patent Application Publication
(10) Pub. No.: US 2007/0185789 A1
(43) Pub. Date: Aug. 9, 2007

(54) Magazine circulation scoring model

(76) Inventor: Gregory J. Zorthian, Greenwich, CT (US)

Correspondence Address: SEYFARTH SHAW LLP, 131 S. DEARBORN ST., SUITE2400, CHICAGO, IL, 60603-5803, US

(21) Appl. No.: 11/704,770

(22) Filed: Feb. 9, 2007

Related U.S. Application Data
(60) Provisional application No. 60/771,662, filed on Feb. 9, 2006.

(51) Int. Cl. G06Q 10/00

(52) U.S. Cl. 705/28

(57) ABSTRACT

The invention pertains a magazine scoring model that includes the evaluation of magazine circulation data reported to a circulation agency. The evaluated data for one specific magazine is then compared to the evaluated data of other magazines, and each magazine is given a score based on its ranking in each of the circulation measures against other magazines. The Magazine Circulation Scoring Model utilizes data collected from publisher's statements and other audit reports, to create a large number of circulation measurements designed to reflect the relative health and vitality of each magazine's circulation. The invention includes the scoring system that includes the distribution of the scoring and ranking data via the internet and the format and display of the reports via computer or internet.

The Present invention claims its priority from co-pending provisional application No. 60/771,662 filed Feb. 9, 2006.

### FIELD OF THE INVENTION

The present invention relates generally to the field of publishing and more specifically to systems for evaluating and scoring the quality of a magazine's circulation based on data base interaction and comparing and ranking the quality of circulation for a group of magazines.

### BACKGROUND OF THE INVENTION

A publisher of a magazine refers to the number of copies sold and distributed as the magazine's circulation. Specifically, a magazine's total net paid subscriptions, single copies sold, and requested and qualified recipients copies contribute to the magazines total circulation. While circulation is measured and tracked for each issue published for the magazine, it is often expressed as an average per issue over six months period.

The publisher uses the circulation of the magazine to set the price for an advertising page in that magazine. A specific level of paid circulation, called a rate base, is established as the minimum level of circulation. The publisher then announces to advertisers that the magazine will guarantee to sell, on average over a six-month period, no fewer copies than the level guaranteed. Based on that level of guaranteed circulation, the publisher then sets the price the magazine will charge for advertising placed in the magazine.

A publisher uses various different methods to sell circulation. The publisher's range of tools can include selling subscriptions directly to new subscribers, renewing subscriptions sold to subscribers in the past, using outside agents to sell subscriptions to subscribers, selling subscriptions to individuals using airline frequent flyer miles, sending copies to individuals sponsored by third parties, selling copies of individual issues to purchasers through retail locations, and selling subscriptions to subscribers in partnership with other organization. In addition, publishers use various tactics to entice customers to purchase subscriptions, including offering subscriptions of different durations, offering prices at different levels of discount, and offering gifts to the individual when a subscription is purchased.

Magazines report a large number of circulation statistics through an industry association know as The Audit Bureau of Circulation (ABC). With more than 4,000 members in North America, ABC is a forum of the world's leading magazine and newspaper publishers, advertisers and advertising agencies. The organization provides credible, verified information essential to the media buying and selling process. ABC maintains the world's foremost electronic database of audited-circulation information and an array of verified readership, subscriber demographics and online activity data.

The publisher reports its circulation claims through the ABC. An ABC Publisher's statement represents the publisher's circulation claims, not yet audited by ABC. These are issued every six months, for periods ending June 30 and December 31 for consumer magazines.

The reported data covers a wide range of performance measurements for the six-month time period. The vehicle to report this data is referred to as a publisher's circulation statement, also know as a pink sheet. The reported data for the six-month period includes the average paid circulation for the magazine, the average paid subscriptions for a magazines, the average single copy sales for a magazine, and the average subscription and single copy price for the magazine. The report also includes aggregated statistics for the six-month period for the number of subscriptions sold, a breakdown of the subscriptions sold by length of term, whether or not the subscription was sold with a premium, and by sales channel. Paid circulation for each issue published in the reporting period is also reported, as well as the single copy sales and the subscription sales for each of those issues. The pink sheet also contains a list of subscriptions sold via predefined programs deemed by the ABC to be exceptions to the usual modes of selling, such as sponsored sales and subscriptions sold using airline frequent flyer miles.

The basic components of an ABC Statement and an ABC Audit Statement for consumer magazines include the following:
Total Average Paid Circulation: Reports circulation by individual subscriptions and single-copy sales. Paid circulation is defined as copies sold at one cent or more.
Prices: Net average price and supplemental analysis of price is reported on a per-copy and annualized basis.
Average Price: This is arrived at by dividing the total price all the issues served during the period by the total number of issues.
Paid by Issue: Paid circulation is reported by issue for the time period covered by the Publisher's Statement. This is accompanied by a supplemental analysis of average paid circulation, if required.
Five-Year Annual Trends: Total average paid and analyzed non-paid circulation for past five years.
Analysis of Total New and Renewal Subscriptions: Describes subscription sales and the amount of individual new and renewal subscriptions sold during the period covered by the report.
Average Circulation of Regional, Metro, and Demographic Editions: Reports on the performance of separate editions. Any edition of a publication that is regularly sold as a separate advertising vehicle is listed individually.
Post-Expiration Copies: Reports the average number of copies served after the subscription has expired. The percentage total is also specified.
Geographic Data: Reflects the geographic distribution (by state or province) of a specific issue chosen by the publisher.
Analysis of Analyzed Non-Paid Circulation: Reports any non-paid circulation to designated recipients of a single issue within each statement period. If there is data to be reported, it is analyzed by recipient (or designated reader) and circulation by age of source.

Explanatory Paragraph: This section is common to all ABC statements. Additional information is detailed here and may include details on: special and promotion programs, combination and sponsored sales, third-party sales, bulk sales, audit cycle, and more, that further explain data included in the body of the statement.

Approximately once each year, the ABC will audit the two magazine's publisher statements for the prior 12-month periods to verify the authenticity of the Publisher's statements. The ABC Audit Report is similar but not identical to a Publisher's Statement. All differences between a Publisher's Statement's claims and the auditor's findings are noted in the ABC Audit Report. The ABC Audit Report either confirms that the Publisher's Statement contained no material misstatements or they identify and quantify discoveries made during the audit process.

Advertising agencies use ABC Statements to evaluate the quality of a publication's circulation when considering the placement of advertising in that publication. Currently there is no standard measurement of quality in the advertising agency industry. Each agency sets it own criteria of benchmarks for what constitutes quality circulation. This process of evaluation usually takes place in the advertising agency's media department. Once a judgment has been reached regarding the quality of the publication's circulation, that information is used by the advertising agency to negotiate the rate it will pay for advertising in the publication. If the advertising agency has decided that the publication has high quality circulation, it is less likely that they will request lower advertising rates. If the advertising agency has decided that the publication has low quality circulation, it will request that the advertising rate it pays be reduced to reflect that lack or quality determination.

Advertising agencies also use ABC Audit Statements to evaluate the delivery of circulation by a publication in which they have advertised. When a publication sets it rate base, which is the level of circulation it guarantees to advertisers and advertising agencies, is bases its advertising rates on that level. The ABC Audit statement verifies whether or not that circulation level is met on an issue by issue basis. The advertising agency reviews the Audit Statements to evaluate whether the publication's guarantee was met. If it was, no action is taken. If it was not, the agency will often use the Audit Statement to request a rebate from the publication.

Publications use ABC Statements in the process of selling advertising. They analyze and evaluate ABC Statements to demonstrate the quality of their circulation and to contrast that quality against the circulation of its competitors. Each publisher develops its own benchmark of quality circulation, often based on the specific areas of circulation strength for that publication. A publisher often reviews its competitor's ABC Statement to discover whether the competitor has weakness in the quality level of its circulation. If the publisher feels that the competitor has weaknesses, the publisher documents those weaknesses. The publisher then incorporates all of this information in its marketing material which promotes the sale of advertising in this publication. This material, among other things, often extols the high level of circulation quality in the publication as a reason for a company or an advertising agency to place advertising in the publication.

The current state of circulation in the publishing industry, the competition among publications for advertising, the lack of circulation understanding, as well as the lack of resources, at advertising agencies, and the lack of impartiality when analyzing circulation quality by publishers demonstrate the great need for this invention.

As the business of selling circulation for publications has become more and more difficult and expensive, publishers have adopted a wide range of strategies and tactics to acquire and retain circulation. Some of the strategies lead to high quality circulation, and some of these strategies lead to low quality circulation. As more and more publishers utilize a broader range of tactics, the level of circulation quality between publications has broadened. Therefore, there is a greater need to understand to differing levels of quality.

Competition among publications to sell advertising has become more and more fierce and circulation quality is one of the major points of differentiation. Yet publishers do not use a standard measure of quality when evaluating circulation. The publishing industry would benefit from the establishment of a uniform measure of circulation quality.

Advertising agencies often lack the expertise and the resources to correctly and accurately evaluate the quality of a publication's circulation. They usually do not have a detailed understanding of how a publication acquires and retains circulation. They are often uninformed on what constitutes quality circulation. They rarely understand how an ABC Statement works and how quality circulation translates onto an ABC Statement. Due to high staff turnover in advertising agencies and the lack of expertise in understanding circulation as well as the lack of resources in developing systems, the advertising agency industry to greatly benefit from the creation of this invention.

Currently, publishers establish their own criteria, often self-serving, when evaluation the quality of the circulation of their publication and well as their competitors. Therefore, their analysis is usually dismissed as biased by advertising agencies. Therefore, publishers, especially those with quality circulation, would benefit from the creation of this invention, as it would create an independent set of measurements.

### SUMMARY OF THE INVENTION

The Magazine Circulation Scoring Model is a process by which the quality of a magazine's circulation performance can be evaluated and scored. This information is of value to advertisers and advertising agencies as they evaluate in which magazines to place their advertising. It is also of value to publishers as they promote their circulation quality of their magazines to the advertisers in the effort to secure the advertising from them.

This Scoring Model includes the evaluation of magazine circulation data, as reported to the Audit Bureau of Circulation (ABC). The evaluated data for one specific magazine is then compared to the evaluated data of other magazines, and each magazine is given a score based on its ranking in each of the circulation measures against other magazines.

The Magazine Circulation Scoring Model utilizes data collected from two sources of information, the ABC Publisher's Statement and the ABC Audit Report, to create a large number of circulation measurements designed to reflect the relative health and vitality of each magazine's circulation. This data is loaded into a database and is updated periodically to reflect the availability of information from the Audit Bureau of Circulation. The data is then evaluated in four categories of measurements. These measurements reflect the quality of the magazine's circulation. The model includes 49 different types of measurements and groups them into 4 different categories: Absolute Measurement, Trends, Veracity, and Competitive Performance. Scores for each measurement, in each category, for a magazine are assigned through the model. The magazine's scores are then measured against similar scores for other magazines against which they will be evaluated. Each compared score is then given a rating, and through this rating system, each magazine being measured is assigned an overall score. Thus the relative quality of each magazine's circulation is quantified into a single score that can be used to compare it against other magazines. A detailed description of the scoring system and scoring is listed below.

In the category of Absolute Measurement, the model evaluates performance in the area of subscription churn, subscriptions sold at a discount, the number of short-term subscriptions sold, subscriptions sold with premiums, subscriptions sold directly to the publisher, subscriptions sold with airline miles, average price per copy, average price per year, and sponsored copies sold. Each magazine title receives a score in each of these categories.

In the category of Trends, the model evaluates each magazine's performance against a prior time period and then compares that performance against the performance of other magazine titles over the same time periods. Changes in price discounting, sales of short term subscriptions, subscriptions sold directly to the publisher, non-cash subscriptions, airline frequent flyer miles subscriptions, changes in price per copy, changes and sponsored copies. Each magazine title receives a score in each of these categories.

In the category of Veracity, the magazine's declared circulation statement is compared against the same period audit report issued by the Audit Bureau of Circulation. The veracity of the magazine's initial claims is measured on an issue by issue basis, and the model scores the number of issues missed at various levels. This is an absolute measurement, where a magazine's performance is rated against what that title claimed rather than the relative performance of the other magazines it is compared against. Each magazine title receives a score based on its own performance.

In the category of Competition, each magazine is ranked in the critical measurements in Absolute Measurement, Trend, and Veracity and is awarded points for their position versus the other magazine titles in the measured group. The measurements include churn, short-term subscriptions, premium sold subscriptions, direct-to-publisher subscriptions, cash subscriptions, transferred subscriptions, changes in these measurements over time, and various measurements of veracity. Each magazine receives a scored based on its ranking in each of these categories.

The Magazine Circulation Scoring Model will be either web based, and accessed by advertising agencies and publishers through the internet, or can be software and a data base which is delivered to the purchaser to be run on the purchaser's own computer.

In an embodiment, the invention provides a system for collecting circulation data for publications for the purpose of determining the quality of the circulation of the publication, comprising collecting circulation data filed by the publisher of the publication, collecting circulation audit data filed by the auditors of circulation data, tagging that data so that it may be analyzed to establish benchmarks in the areas of performance, trends, accuracy and creating a database and storing that data in the database so it may be analyzed.

The system may collect data by obtaining publisher's data via a data feed or collect data in paper format. The system may be accomplished by obtaining auditor's data via a data feed or collect data in paper format. The system may further comprise a system to tag data so that the data is identifiable by name of publication, date of the report, type of report, data type, and issue data. The system may further comprise the step of loading data into a proprietary, secure database so that the data can be accessed by processing programs.

In a further embodiment the invention provides a method of analyzing circulation data for publications for the purpose of determining the quality of the circulation of the publication comprising analyzing the data to establish benchmarks for the quality of the publications circulation, analyzing the data to establish benchmarks for the improvement or decline of the quality of the circulation over time and analyzing the data to establish the accuracy of the publishers reporting of its circulation data. The method may further comprise evaluating specific data points using circulation quality measurements to determine quality levels. The method may further comprises evaluating specific data points trends over time using circulation quality measurements to determine improvement or decline.

The method of claim may further comprises evaluating specific data points of accuracy using circulation quality measurements and auditor reports to determine quality of reporting and performance. The method may further comprise comparing a score for the quality of circulation for publications or different circulation size and different publishing frequency comprising comparing and ranking the quality of absolute circulation performance across a range of different publications.

The method may further comprise comparing a score for the quality of circulation for publications or different circulation size and different publishing frequency comprising comparing and ranking the quality of circulation performance trends over time across a range of different publications. The method may further comprise comparing a score for the quality of circulation for publications or different circulation size and different publishing frequency comprising establishing the accuracy of circulation for performance and then comparing the accuracy of that reporting across a range of publications. The method may further comprise comparing a score for the quality of circulation for publications or different circulation size and different publishing frequency comprising ranking how a selected group of publications performed when compared against each other.

The method may further comprise comparing a score for the quality of circulation for publications or different circulation size and different publishing frequency comprising assigning a score to each publication for its performance in each benchmark used to analyze and establish the level of circulation quality for that publication. The method may further comprise comparing a score for the quality of circulation for publications or different circulation size and different publishing frequency comprising establishing a method to evaluate and compare the different levels of quality circulation for a publication so as to more efficiently and more effectively purchase advertising in that publication. The method may further comprise comparing a score for the quality of circulation for publications or different circulation size and different publishing frequency comprising using overall scores, as well as category scores, to understand level of quality of each publication being evaluated and determining the importance of that level of quality in the purchase of advertising.

In an embodiment, the invention provides a system for analyzing circulation data comprising a computer having storage medium and a processor, the storage medium for receiving circulation data and audit data and the processor analyzing the data and outputting benchmark data. The system may provide a processor that outputs data pertaining to a level of circulation quality for that publication. The system may provide a processor that outputs rankings that identify performance of a selected group of publications when compared against each other. The system may provide a processor that is connected to a server and the rankings are delivered via the internet to users.

### BRIEF DESCRIPTION OF THE DRAWINGS

For the purpose of facilitating an understanding of the invention, there is illustrated in the accompanying drawings an embodiment thereof, from an inspection of which, when considered in connection with the following description, the invention, its construction and operation, and many of its advantages should be readily understood and appreciated.

FIG. 1 is a flow chart diagram of an embodiment of the Magazine Circulation Scoring Model (MCSM) Invention Data Collection process;

FIG. 2 is a flow chart diagram of the MCSM invention user inquiry process;

FIG. 3 is a flow chart diagram of the MCSM invention output process;

FIG. 4 is a sample chart depicting measurement categories and data for a particular MCSM embodiment;

FIG. 5 is a sample chart depicting scoring output data for a particular MCSM embodiment; and

FIG. 6 is a diagram of the system architecture of an embodiment of the present invention.

### DETAILED DESCRIPTION

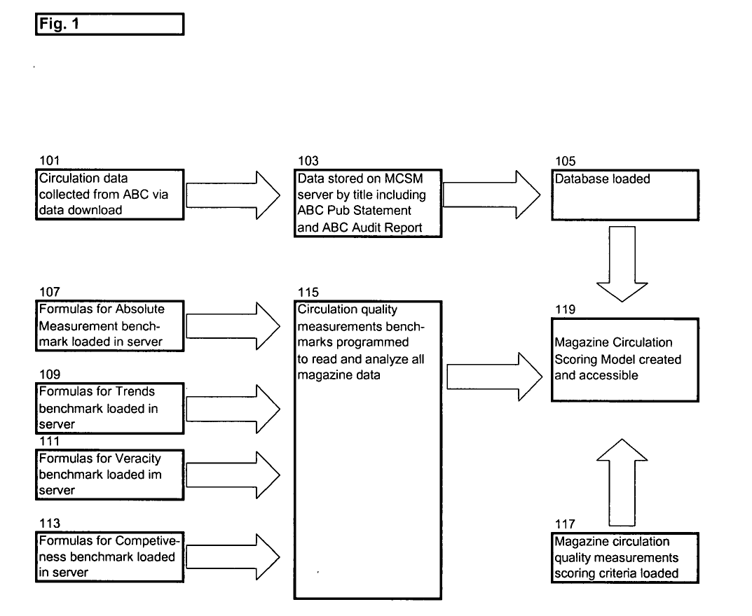

FIGS. 1-6 depict an embodiment of the present invention. FIG. 1 is a flow chart diagram that shows how an embodiment of the Magazine Circulation Scoring Model (MCSM) is created. Data is obtained from the Audit Bureau of Circulation 101 and that data is loaded on the Model servers 103. Data is tagged and categorized so that it can be accessed in its most detailed form 103. The data is tracked by specific time period and type of information so that it can most accurately reflect the magazine's performance and what the magazine reports on the Publisher's ABC Statement. The same rigorous tagging is applied to the Audit Statement. Once the data is tagged, the data is stored into the Magazine Circulation Scoring Model server 105.

Concurrently, the program containing the formulas to set the benchmark for each title in the areas of Absolute Measurement 107, Trends 109, Veracity 111, and Competitiveness 113 is also loaded on to the server. The program then accesses the ABC data in the database and creates a profile of each magazine, which can later be used to create the circulation quality scores for each magazine 115.

Also, the magazine circulation quality measurements scoring criteria is also loaded into the service 117. This program is the process by which the circulation score is eventually assigned to a magazine. The program is designed to look at the magazine's performance in each of the forty-nine areas of evaluation, read whether the magazine has the best performance, the second best performance, or the third or subsequent best performance. If the title has the best performance, it is assigned fifteen points. If the title has the second best performance, it is assigned ten points. If the performance is third or subsequent, it received five points. The total points assigned for all of the areas of evaluation is the magazine's score, with the magazine with the highest number of points having the highest quality circulation or the titles being compared and the magazine with the lowest number of points with the least quality circulation of the title being compared.

With the completion of the loading of the ABC database, the measurement formulas, the initial magazine analysis, and the scoring criteria, the Magazine Circulation Scoring Model is available to analyze magazine sets 119.

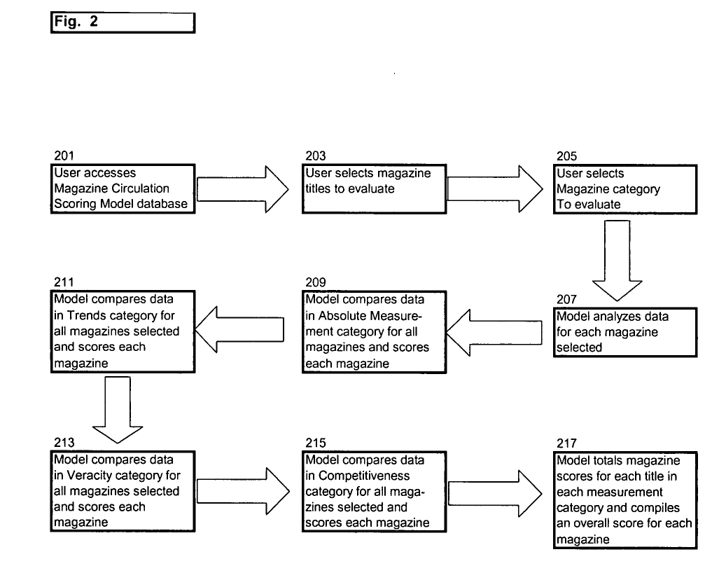

FIG. 2 demonstrates the process by which a user, either an advertising agency user, an advertiser, or a magazine publisher, obtains information from the Magazine Circulation Scoring Model. The user accesses the server, which contains the ABC data, the program to set the benchmarks, and the program to score the magazine's performance via a PC 201 or personal digital assistant (PDA). Once the user has access to the scoring model, the user selects the magazine category 205, or set of magazine titles 203 to evaluate. The model accesses the data for the set of magazines and analyzes data for each of the magazines selected 207. The model compares the benchmarks in the Absolute Measurement category and assigns scores for each of the benchmarks for each of the magazines 209. The model compares the benchmarks in the Trends category and assigns scores for each of the benchmarks for each of the magazines 211. The model compares the benchmarks in the Veracity category and assigns scores for each of the benchmarks for each of the magazines 213. The model compares the benchmarks in the Competitiveness category and assigns scores for each of the benchmarks for each of the magazines 215. The model totals each magazine's scores for the four categories and assigns each magazine an overall score based on the quality of the magazine's circulation 217.

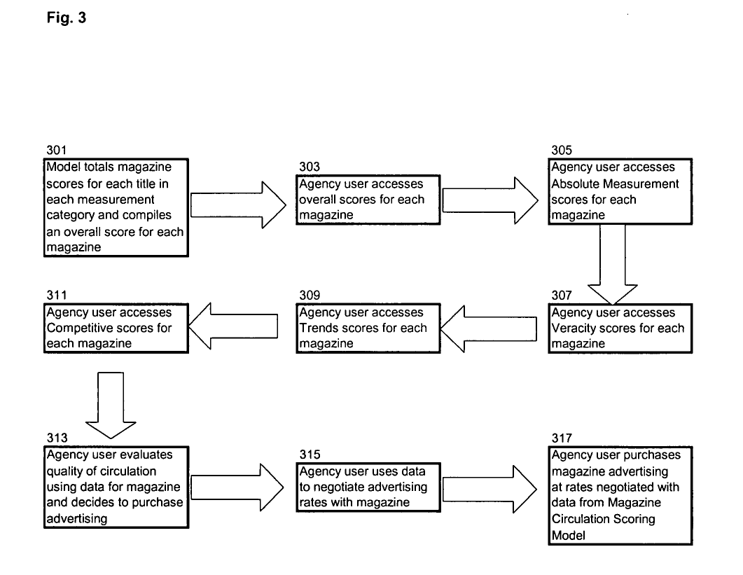

In FIG. 3 the Magazine Circulation Scoring Model assigns scores for each measurement category and compiles an overall score for each magazine evaluated 301. The user, in this case an advertising agency user, accesses the overall score online and prints out the results 303. The user then accesses the Absolute Measurement score online and prints out the results 305. The user then accesses the Veracity score online and prints out the results 307. The user then accesses the Trends score online and prints out the results 309. The user then evaluates the selected magazines using the scoring sheets from the Magazine Circulation Scoring Model and decides which magazine has the appropriate level of quality circulation and where to place the advertising 313. The agency user then negotiates an advertising rate with the magazine using the data 315 and purchases the advertising at the agreed upon rate 317.

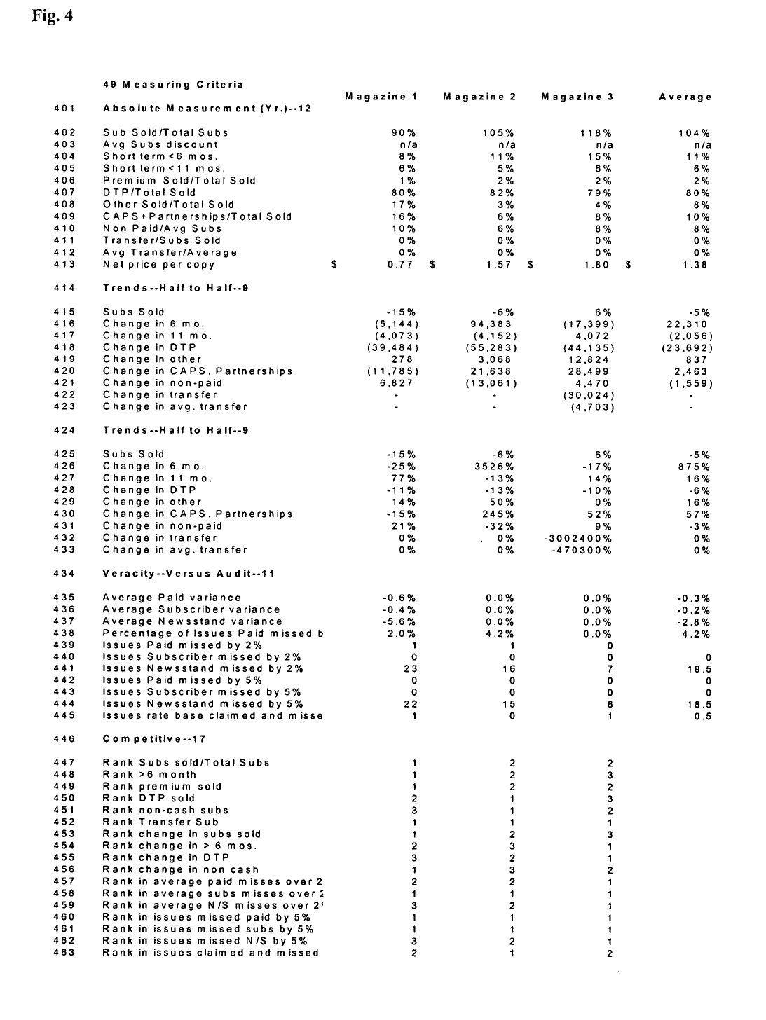

Once several years of data has been acquired and loaded into the database, the Scoring Model Program can analyze the data and create a series of ratios and performance indications. Specifically, the types of analysis fall into the following areas: FIG. 4 shows the forty-nine different measurement categories and the specific criteria evaluated to create a basis to score the quality of each magazine's circulation. The four major categories are shown: Absolute Measurement 401-413, Trends 414-433, Veracity 434-445, and Competitiveness 446-463 with sample data in each measurement.

Absolute Measurement category has twelve criteria including 402: Number of subscriptions sold over a one-year period divided by average number of paid subscriptions delivered over the same period. A percentage closest to the average of all the magazines being compared indicates higher quality circulation. 403: Number of discount subscriptions sold over a one-year period divided by total subscriptions sold. A small percentage of discounted subscriptions indicate higher quality circulation. 404: Number of short-term (6 months or less) subscriptions sold over a one-year period divided by total subscriptions sold over the same period. A small percentage of short-term subscriptions indicate higher quality circulation. 405: Number of short-term (6 months to 11 months or less) subscriptions sold over a one-year period divided by total subscriptions sold over the same period. A small percentage of short-term subscriptions indicate higher quality circulation.

406: Number of subscriptions sold with non-editorial premiums over a one-year period divided by total subscriptions sold. A small percentage of premium sold subscriptions indicate higher quality circulation. 407: Number of subscriptions sold direct-to-publisher over a one-year period divided by total subscriptions sold. A high percentage of direct-to-publisher subscriptions indicate higher quality circulation. 408: Number of other subscriptions sold over a one-year period divided by total subscriptions sold. A small percentage of other subscriptions indicate higher quality circulation.

409: Number of subscriptions sold through partnerships or purchased with airline frequent flyer miles over a one-year period divided by total subscriptions sold. A small percentage of partnership and airline frequent flyer miles subscriptions indicate higher quality circulation. 410: Number of non-paid subscriptions delivered over a one-year period divided by total subscriptions sold. A small percentage of non-paid subscriptions indicate higher quality circulation. 411: Number of transferred subscriptions acquired over a one-year period divided by total subscriptions sold. A small percentage of transfer subscriptions indicate higher quality circulation. 412: Number of transferred subscriptions delivered over a one-year period divided by total subscriptions sold. A small percentage of discounted subscriptions indicate higher quality circulation. 413: Average net price per subscription copy sold. A higher price represents higher quality circulation.

The next category is Trends, Half year period to prior year same period 414 that has nine criteria including 415, 425: Change in number of subscriptions sold. A decrease in the percentage of subscriptions sold represents higher quality. 416, 425: Change in number of short-term (less than 6 months) subscriptions sold. A decrease in the percentage of subscriptions sold represents higher quality. 417, 427: Change in number of short-term (6 to 11 months) subscriptions sold. A decrease in the percentage of subscriptions sold represents higher quality. 418, 428: Change in number direct-to-publisher subscriptions sold. An increase in the percentage of subscriptions sold represents higher quality. 419, 429: Change in number of other subscriptions sold. A decrease in the percentage of other subscriptions sold represents higher quality. 420, 430: Change in number of partnership and frequent flyer miles subscriptions sold. A decrease in the percentage of partnership and frequent flyer miles subscriptions sold represents higher quality. 421, 431: Change in average number of non-paid subscriptions delivered. A decrease in the percentage of average non-paid subscriptions delivered represents higher quality. 422, 432: Change in number of transfer subscriptions sold. A decrease in the percentage of transferred subscriptions delivered represents higher quality. 423, 433: Change in average number of transferred subscriptions delivered. A decrease in the percentage of transferred subscriptions delivered represents higher quality.

The next category is Veracity, Publisher's Statement compared to Audit Statement 434 that has eleven criteria including 435: Variance of average paid total circulation claimed on the Publisher's Statement versus average paid total circulation reported on the Audit Statement. A positive variance percentage (i.e. Publisher's statement is higher than Audit Statement) represents higher quality circulation. 436: Variance of average paid subscription circulation claimed on the Publisher's Statement versus average paid subscription circulation reported on the Audit Statement. A positive variance percentage (i.e. Publisher's statement is higher than Audit Statement) represents higher quality circulation. 437: Variance of average paid newsstand circulation claimed on the Publisher's Statement versus average paid newsstand circulation reported on the Audit Statement. A positive variance percentage (i.e. Publisher's statement is higher than Audit Statement) represents higher quality circulation. 438: Percentage of total issues with lower audited circulation than claimed on the Publisher's statement. The lower percentage represents higher quality circulation. 439: Number of issues average paid total circulation claimed on the Publisher's Statement was between 2% and 5% less than the average paid total circulation reported on the Audit Statement. Fewer issues represent higher quality circulation. 440: Number of issues average paid subscription circulation claimed on the Publisher's Statement was between 2% and 5% less than the average paid subscription circulation reported on the Audit Statement. Fewer issues represent higher quality circulation. 441: Number of issues average paid newsstand circulation claimed on the Publisher's Statement was between 2% and 5% less than the average newsstand total circulation reported on the Audit Statement. Fewer issues represent higher quality circulation.

442: Number of issues average paid total circulation claimed on the Publisher's Statement was over 5% less than the average paid total circulation reported on the Audit Statement. Fewer issues represent higher quality circulation. 443: Number of issues average paid subscription circulation claimed on the Publisher's Statement was over 5% less than the average paid subscription circulation reported on the Audit Statement. Fewer issues represent higher quality circulation. 444: Number of issues average paid newsstand circulation claimed on the Publisher's Statement was over 5% less than the average newsstand total circulation reported on the Audit Statement. Fewer issues represent higher quality circulation. 445: Number of issues claimed by the Publisher to have delivered rate base on the Publisher's Statement but were under rate base on the Audit Report. Fewer issues represent higher quality circulation.

The final category is Competitive Comparisons 446 that has seventeen criteria including 447: Rank magazines being compared on quality of subscriptions sold as a percentage of average subscriptions delivered. 448: Rank magazines being compared on quality of 6-month subscriptions sold as a percentage of total subscriptions sold. 449: Rank magazines being compared on quality of subscriptions sold with premiums as a percentage of total subscriptions sold. 450: Rank magazines being compared on quality of subscriptions sold with direct-to-publisher as a percentage of total subscriptions sold. 451: Rank magazines being compared on quality of non-cash subscriptions sold as a percentage of total subscriptions sold. 452: Rank magazines being compared on quality of transfer subscriptions sold as a percentage of total subscriptions sold. 453: Rank magazines being compared on quality changes in percentage of subscriptions sold as a percentage of total subscriptions sold. 454: Rank magazines being compared on quality of change in 6-month subscriptions sold as a percentage of total subscriptions sold. 455: Rank magazines being compared on quality of change in subscriptions sold with direct-to-publisher as a percentage of total subscriptions sold. 456: Rank magazines being compared on quality of change in non-cash subscriptions sold as a percentage of total subscriptions sold. 457: Rank magazines in number of issues that missed delivering the claimed total paid circulation by 2%-5%. 458: Rank magazines in number of issues that missed delivering the claimed total paid subscriptions by 2%-5%. 459: Rank magazines in number of issues that missed delivering the claimed total paid newsstand sales by 2%-5%. 460: Rank magazines in number of issues that missed delivering the claimed total paid circulation by over 5%. 461: Rank magazines in number of issues that missed delivering the claimed total paid subscriptions by over 5%. 462: Rank magazines in number of issues that missed delivering the claimed total paid newsstand sales by over 5%. 463: Rank magazines in number of issues publisher claimed to have made rate base and was shown to have missed rate base in its Audit Statement.

The next step in the system is scoring. To develop a quality score for a magazine, that magazine's performance in each of the forty-nine measures of quality is compared and evaluated against the performance in each of those forty-nine categories for the other magazine titles it is being compared against. Each magazine in the comparative set receives a score for each of the 49 different categories. The magazine with the best quality circulation in a specific category would receive 15 points. The magazine with the second best quality circulation in that category would receive 10 points. The magazine with the third best quality performance in that benchmark would receive 5 points, and any additional magazine being evaluated with the group would also receive 5 points.

Thereafter, each magazine would receive a score for each of the forty-nine benchmarks in the four evaluative categories of Absolute Measurement, Trends, Veracity, and Competitive Comparisons. These forty-nine scores would then be totaled, and the magazine with the highest score would be considered the magazine with the best quality circulation. The highest score a magazine could receive would be 735 points and the lowest score a magazine could receive would be 245 points.

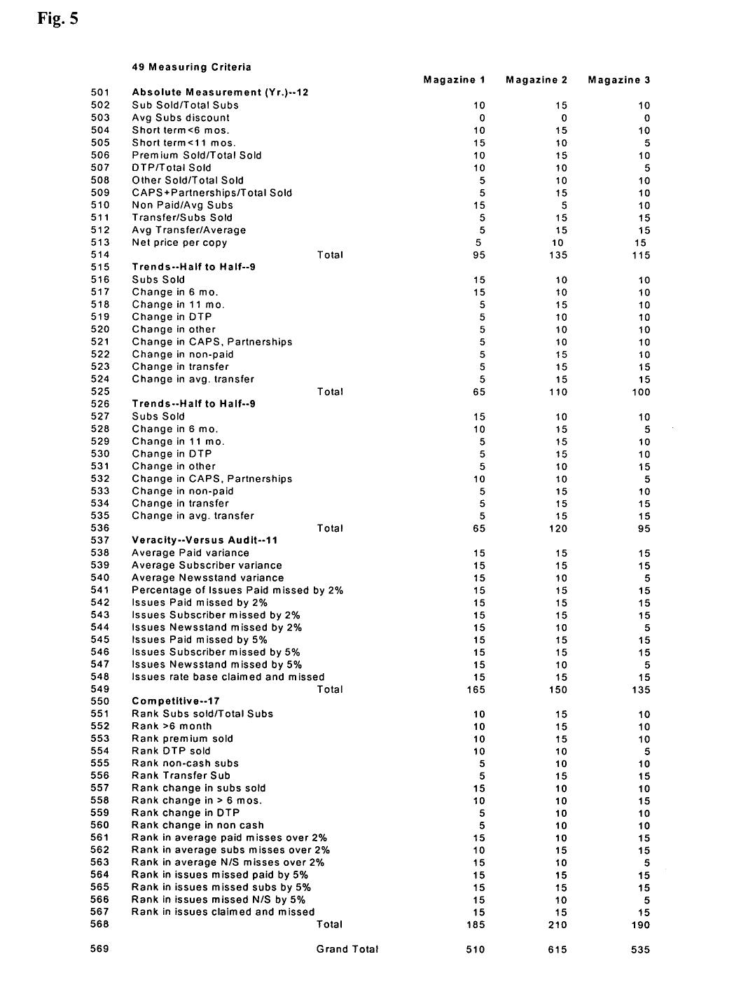

FIG. 5 is an example of the scoring output from the Model. It shows sample scores for each benchmark in each category, with totals for each magazine in each category and a grand total for all four categories described above with respect to FIG. 4. It shows that magazine 2 has the highest quality circulation of the three magazines evaluated in this example.

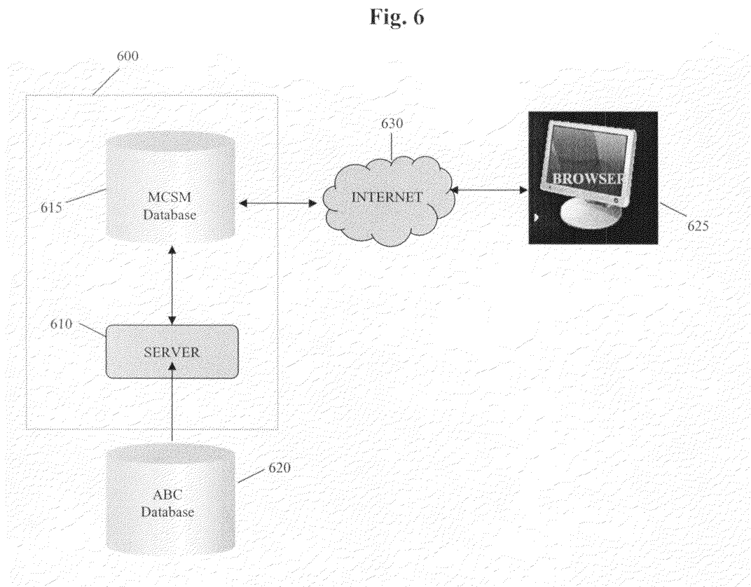

FIG. 6 is a diagram of the system architecture for an embodiment of the present invention. An enterprise system 600 may be provided that includes hardware and software components including a server 610 and a database 615. Other components such as personal computers and peripheral devices are included as well. The enterprise system 600 is connected to the ABC database 620 and outside computers or PCs 625 or other client devices. The connection to the ABC database 620 or computers 625 may be via the internet 630 and data packets may be transmitted and received to and from the system 600. The MCSM system includes the enterprise system 600 and the peripheral data bases and computers. Each of the components include storage medium and processors. This model can be run using either proprietary, custom software, or as using Microsoft Excel, which was used to create the prototype. The formulas used to set the benchmarks are straightforward and easy to create in Excel. Excel's data storage capabilities will allow for an initial database to be created.

Implementations consistent with the principles of the invention are not limited to evaluating and ranking the quality of magazine circulation using circulation data as provide to the Audit Bureau of Circulation. For example, any publication, including newspapers, magazines, and other periodicals, publicly reporting it circulation statistics through any organization may be evaluated in implementations consistent with the principals of the invention.

While particular embodiments have been shown and described, it will be apparent to those skilled in the art that changes and modifications may be made without departing from the principles of the invention in its broader aspects. Details set forth in the foregoing description and accompanying drawings are offered by way of illustration only and not as a limitation. The actual scope of the present invention is intended to be defined in the following claims when viewed in their proper perspective based on the prior art.

What is claimed is:

1. A system for collecting circulation data for publications for the purpose of determining the quality of the circulation of the publication, comprising:
a. collecting circulation data filed by the publisher of the publication;
b. collecting circulation audit data filed by the auditors of circulation data;
c. tagging that data so that it may be analyzed to establish benchmarks in the areas of performance, trends, accuracy; and
d. creating a database and storing that data in the database so it may be analyzed.

2. The system of claim 1 wherein the collecting may be accomplished by obtaining publisher's data via a data feed or collect data in paper format.

3. The system of claim 1 wherein the collecting may be accomplished by obtaining auditor's data via a data feed or collect data in paper format.

4. The system of claim 1 further comprising a system to tag data so that the data is identifiable by name of publication, date of the report, type of report, data type, and issue data.

5. The system of claim 1 wherein the creating step further comprises the step of loading data into a proprietary, secure database so that the data can be accessed by processing programs.

6. A method of analyzing circulation data for publications for the purpose of determining the quality of the circulation of the publication comprising:
a. analyzing the data to establish benchmarks for the quality of the publications circulation;
b. analyzing the data to establish benchmarks for the improvement or decline of the quality of the circulation over time; and
c. analyzing the data to establish the accuracy of the publishers reporting of its circulation data.

7. The method of claim 6 wherein the analyzing step further comprises evaluating specific data points using circulation quality measurements to determine quality levels.

8. The method of claim 6 wherein the analyzing step further comprises evaluating specific data points trends over time using circulation quality measurements to determine improvement or decline.

9. The method of claim 6 wherein the analyzing step further comprises evaluating specific data points of accuracy using circulation quality measurements and auditor reports to determine quality of reporting and performance.

10. The method of claim 6 further comprising comparing a score for the quality of circulation for publications or different circulation size and different publishing frequency comprising comparing and ranking the quality of absolute circulation performance across a range of different publications.

11. The method of claim 6 further comprising comparing a score for the quality of circulation for publications or different circulation size and different publishing frequency comprising comparing and ranking the quality of circulation performance trends over time across a range of different publications.

12. The method of claim 6 further comprising comparing a score for the quality of circulation for publications or different circulation size and different publishing frequency comprising establishing the accuracy of circulation for performance and then comparing the accuracy of that reporting across a range of publications.

13. The method of claim 6 further comprising comparing a score for the quality of circulation for publications or different circulation size and different publishing frequency comprising ranking how a selected group of publications performed when compared against each other.

14. The method of claim 6 further comprising comparing a score for the quality of circulation for publications or different circulation size and different publishing frequency comprising assigning a score to each publication for its performance in each benchmark used to analyze and establish the level of circulation quality for that publication.

15. The method of claim 6 further comprising comparing a score for the quality of circulation for publications or different circulation size and different publishing frequency comprising establishing a method to evaluate and compare the different levels of quality circulation for a publication so as to more efficiently and more effectively purchase advertising in that publication.

16. The method of claim 6 further comprising comparing a score for the quality of circulation for publications or different circulation size and different publishing frequency comprising using overall scores, as well as category scores, to understand level of quality of each publication being evaluated and determining the importance of that level of quality in the purchase of advertising.

17. A system for analyzing circulation data comprising:
a computer having storage medium and a processor, the storage medium for receiving circulation data and audit data; and
the processor analyzing the data and outputting benchmark data.

18. The system of claim 17 wherein the processor outputs data pertaining to a level of circulation quality for that publication.

19. The system of claim 17 wherein the processor outputs rankings that identify performance of a selected group of publications when compared against each other.

20. The system of claim 19 wherein the processor is connected to a server and the rankings are delivered via the internet to users.
